(19) United States
(12) Patent Application Publication
(10) Pub. No.: US 2015/0261746 A1
(43) Pub. Date: Sep. 17, 2015

(54) TRANSLATION SYSTEM, INFORMATION PROCESSING APPARATUS, INFORMATION PROCESSING METHOD, AND COMPUTER PROGRAM PRODUCT

(71) Applicant: Saeko SHIMAZU, Kanagawa (JP)

(72) Inventor: Saeko SHIMAZU, Kanagawa (JP)

(73) Assignee: RICOH COMPANY, LTD., Tokyo (JP)

(21) Appl. No.: 14/640,578

(22) Filed: Mar. 6, 2015

(30) Foreign Application Priority Data
Mar. 11, 2014 (JP) 2014-047489

(51) Int. Cl. G06F 17/28

(52) U.S. Cl. CPC G06F 17/289

(57) ABSTRACT

A translation system includes one or more computers, and the translation system includes an acquiring unit that acquires original information indicating text to be translated and designation information including information for designating a specialized field that is a field to which the original information belongs, a storage unit that stores therein, for each of specialized fields, one or more pieces of technical dictionary information each being used as a dictionary for translation of a word/phrase used in each of the specialized fields, a recognizing unit that recognizes a word/phrase to be translated by using one or more pieces of the technical dictionary information corresponding to the specialized field designated by the designation information among words/phrases contained in the original information, and an adding unit that adds information indicating a translation result of a word/phrase to only the word/phrase recognized by the recognizing unit.

### CROSS-REFERENCE TO RELATED APPLICATIONS

The present application claims priority to and incorporates by reference the entire contents of Japanese Patent Application No. 2014-047489 filed in Japan on Mar. 11, 2014.

### BACKGROUND OF THE INVENTION

1. Field of the Invention

The present invention relates to a translation system, an information processing apparatus, an information processing method, and a computer program product.

2. Description of the Related Art

Conventionally, there is a known technology of machine translation for translating text contained in a paper document or an electronic document to a designated language and printing or outputting a translation result to an electronic document, hypertext, or the like.

### SUMMARY OF THE INVENTION

It is an object of the present invention to at least partially solve the problems in the conventional technology.

There is provided a translation system including one or more computers, the translation system including: an acquiring unit that acquires original information indicating text to be translated and designation information including information for designating a specialized field that is a field to which the original information belongs; a storage unit that stores therein, for each of specialized fields, one or more pieces of technical dictionary information each being used as a dictionary for translation of a word/phrase used in each of the specialized fields; a recognizing unit that recognizes a word/phrase to be translated by using one or more pieces of the technical dictionary information corresponding to the specialized field designated by the designation information among words/phrases contained in the original information; and an adding unit that adds information indicating a translation result of a word/phrase to only the word/phrase recognized by the recognizing unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a configuration of a system according to a first embodiment;

FIG. 2 is a diagram illustrating an example of a screen provided by a special application installed in an MFP;

FIG. 3 is a diagram illustrating an example of a functional configuration of a server according to the first embodiment;

FIGS. 4A and 4B are diagrams illustrating an example of a correspondence map;

FIGS. 5A to 5D are diagrams illustrating an example of translated information;

FIG. 6 is a flowchart illustrating an example of operation performed by a translating unit;

FIGS. 7A to 7D are diagrams illustrating a specific example of a translation process using an analysis result of a structure of text and basic dictionary information together with technical dictionary information;

FIG. 8 is a diagram illustrating an example of a system according to a second embodiment;

FIG. 9 is a diagram illustrating an example of a functional configuration of a server according to the second embodiment; and

FIG. 10 is a diagram illustrating an exemplary screen of a dedicated page on the server.

### DETAILED DESCRIPTION OF THE PREFERRED EMBODIMENTS

Exemplary embodiments of a translation system, an information processing apparatus, an information processing method, and a computer program product according to the present invention will be described in detail below with reference to the accompanying drawings.

For example, Japanese Laid-open Patent Publication No. 2007-286925 provides a mechanism that performs machine translation on only input text with a higher level of difficulty than a level of difficulty designated by a user in the entire text, and outputs input text with a lower level of difficulty than the level of difficulty set by the user as it is in an original, to thereby automatically extract and translate text which a user may not be able to translate or a translation result of which may not be fully understood.

However, in the conventional machine translation, when a translation result is grammatically or contextually incorrect, translated text may cause confusion and hinder the understanding.

In this case, a user of high ability in translation may be able to refer to the translated text with respect to only an unknown technical term or expression in line with a context or structure of text in the original. However, in the conventional machine translation, it is difficult to instantly recognize corresponding portions of the translation result to the original, and operation of searching for the corresponding portions is a burden on the user.

The present invention has been conceived in view of the above, and there is a need for a translation system, an information processing apparatus, an information processing method, and a computer program product capable of assisting in understanding an original while reducing a burden on a user.

### First Embodiment

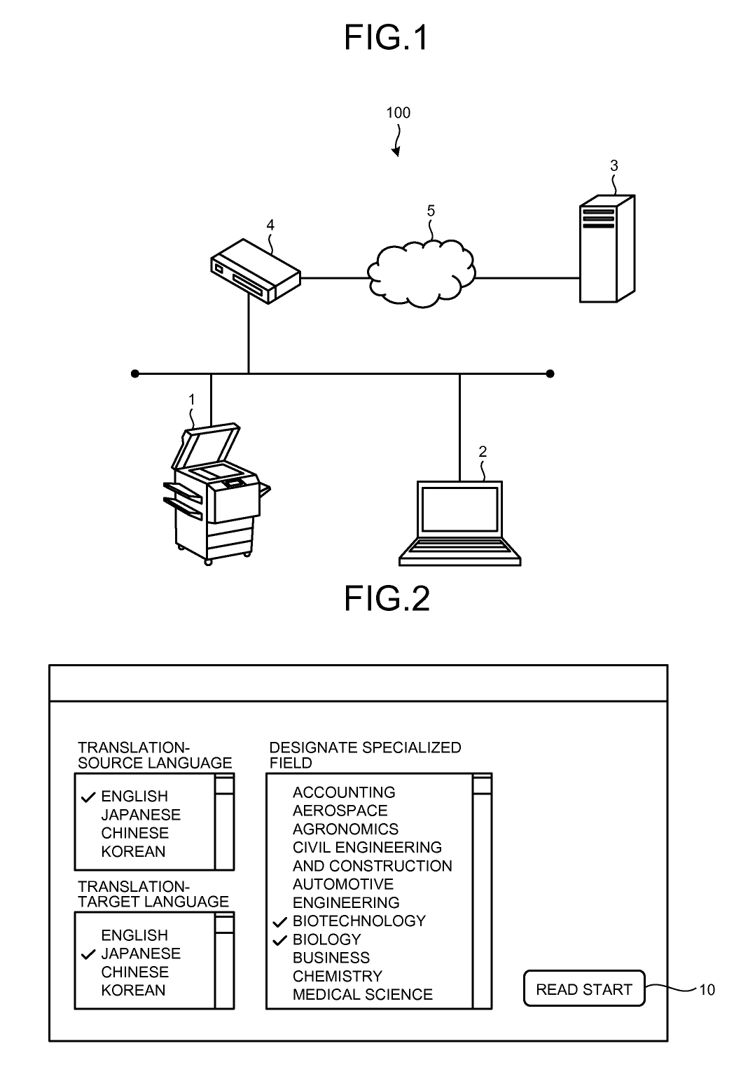

FIG. 1 is a diagram illustrating an example of a configuration of a translation system 100 according to a first embodiment. As illustrated in FIG. 1, the translation system 100 includes a multifunction peripheral (MFP) 1, a personal computer (PC) 2, and a server 3. In the example in FIG. 1, the MFP 1 and the PC 2 are connected to the server 3 via a router 4 and an Internet 5. The MFP 1 and the PC 2 may be arranged on the same network as in the example in FIG. 1, or the MFP 1 and the PC 2 may access the server 3 from different networks.

The MFP 1 is an apparatus (image forming apparatus) having various functions, such as a copier function, a scanner function, a facsimile function, and a printer function. In this example, a special application (software) for providing a function to generate designation information including at least information for designating a specific specialized field according to user's operation is installed in the MFP 1. The MFP 1 scans a document, generates original information indicating text to be translated, and transmits the generated original information and the designation information described above to the server 3.

FIG. 2 is a diagram illustrating an example of a screen provided by the special application installed in the MFP 1. The special application is an application for providing a function to generate designation information for designating a translation-source language (a language used to write text (original) to be translated), a translation-target language (a language used to write a translation result), and a specialized field corresponding to the content of the original (a specialized field as a field to which the original belongs) according to user's operation. It may be possible to employ a configuration that allows for designation of a plurality of types of specialized fields, for example. In this specification, the “specialized field” includes at least one of a specialized field, a major field, a research field, and an academic field.

A user performs operation of designating each of the translation-source language, the translation-target language, and the specialized field while watching the screen illustrated in FIG. 2, and the MFP 1 generates designation information for designating the translation-source language, the translation-target language, and the specialized field according to the user's operation. When the user presses a read start button (user interface (UI) button) 10 illustrated in FIG. 2, the MFP 1 performs operation of scanning and reading an image of a document. In this example, the MFP 1 performs a character recognition process on the read image (a document image), and transmits information, in which a document image is reconstructed by reflecting a result of the character recognition process (may be original information indicating text to be translated), to the server 3. However, the configuration is not limited to the above, and may be such that, for example, the MFP 1 transmits the read document image to the server 3, and the server 3 performs the character recognition process and acquires the original information indicating text to be translated. As the character recognition process, various well-known techniques are applicable. That is, any configuration is applicable as long as the server 3 acquires the original information indicating text to be translated.

The server 3 performs a translation process on the original information acquired from the MFP 1, and stores therein a file indicating a result of the translation process. The PC 2 connects to (accesses) the server 3 via an Internet browser or a special application, and downloads or views the file indicating the result of the translation process. In other words, the server 3 outputs information indicating the result of the translation process in response to a request from the PC 2.

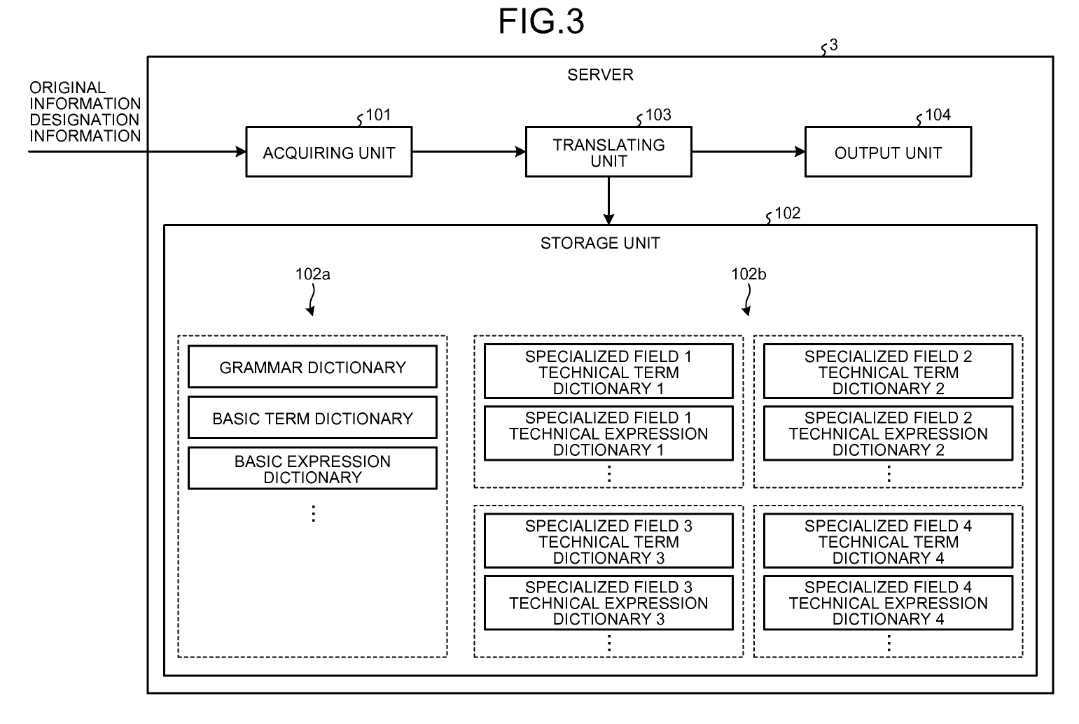

Next, a configuration of the server 3 will be described. In this example, the server 3 corresponds to an “information processing apparatus” in the appended claims. FIG. 3 is a block diagram illustrating an example of a functional configuration of the server 3. As illustrated in FIG. 3, the server 3 includes an acquiring unit 101, a storage unit 102, a translating unit 103, and an output unit 104. The acquiring unit 101 acquires the original information and the designation information as described above from the MFP 1.

The storage unit 102 stores therein, for each of specialized fields, one or more pieces of dictionary information each being used as a dictionary for translation of a word/phrase used in each of the specialized fields. Details will be described below. In the first embodiment, the storage unit 102 stores therein a basic data group 102a which includes grammar information needed for translation and dictionary information on common words and common expressions, and a technical data group 102b in which pieces of dictionary information on terms and expressions for each of the specialized fields are grouped together for each of the specialized fields.

In the example in FIG. 3, the basic data group 102a includes, for each of languages, a grammar dictionary that stores therein grammar information indicating a grammar rule for each of the languages in an associated manner. Further, the basic data group 102a stores therein, for each combination of the translation-source language and the translation-target language (for example, Japanese and English, Japanese and Chinese, English and Chinese, and the like), a basic term dictionary indicating a correspondence relation between the translation-source language and the translation-target language for commonly-used words in an associated manner, although details are not illustrated in the drawings. In this specification, a “word” is a smallest meaningful unit (a structural unit of a language), and is formed of one or more morphemes. For example, the “word” may be a single word, a compound word, and the like.

Furthermore, the basic data group 102a stores therein, for each combination of the translation-source language and the translation-target language, a basic expression dictionary indicating a correspondence relation between the translation-source language and the translation-target language for commonly-used phrases (expressions) in an associated manner, although details are not illustrated in the drawings. In this specification, a “phrase” indicates a sequence of words that collectively indicate a single meaning. A “word/phrase” includes at least one of a “word” and a “phrase” (may be one or more character strings). In the following description, the basic term dictionary and the basic expression dictionary may be simply referred to as “basic dictionary information” when they need not be distinguished from each other.

In the example in FIG. 3, the technical data group 102b stores therein, for each of the specialized fields, a technical term dictionary indicating a correspondence relation between the translation-source language and the translation-target language for words used in each of the specialized fields in an associated manner. For example, a “specialized field 1” is associated with a technical term dictionary 1 indicating a correspondence relation between the translation-source language and the translation-target language for a plurality of words used in the specialized field 1. In this example, the technical term dictionary corresponds to “first technical dictionary information” in the appended claims.

In the example in FIG. 3, the technical data group 102b stores therein, for each of the specialized fields, a technical expression dictionary indicating a correspondence relation between the translation-source language and the translation-target language for phrases used in each of the specialized fields in an associated manner. For example, the “specialized field 1” is associated with a technical expression dictionary 1 indicating a correspondence relation between the translation-source language and the translation-target language for a plurality of phrases used in the specialized field 1. In this example, the technical term dictionary corresponds to “the second technical dictionary information” in the appended claims. In the following description, the technical term dictionary and the technical expression dictionary may be simply referred to as “technical dictionary information” when they need not be distinguished from each other. Further, the basic dictionary information and the technical dictionary information may be simply referred to as “dictionary information” when they need not be distinguished from each other.

The translating unit 103 performs a translation process on the original information acquired by the acquiring unit 101. In the first embodiment, the translating unit 103 recognizes a word/phrase to be translated by using one or more pieces of the technical dictionary information corresponding to the specialized field designated by the designation information acquired by the acquiring unit 101, from among words/phrases contained in the original information acquired by the acquiring unit 101. Specifically, the translating unit 103 analyzes a structure of text in the original information, and recognizes a word/phrase to be translated by using one or more pieces of the technical dictionary information corresponding to the specialized field designated by the designation information, from among the words/phrases contained in the original information. Details will be further described below. In this example, the translating unit 103 has functions corresponding to an “analyzing unit” in the appended claims; however, it is not limited thereto. For example, the functions corresponding to the “analyzing unit” in the appended claims may be provided separately from the translating unit 103. Further, in this example, the translating unit 103 has functions corresponding to a “recognizing unit” in the appended claims; however, it is not limited thereto. For example, the functions corresponding to the “recognizing unit” in the appended claims may be provided separately from the translating unit 103.

In the first embodiment, the translating unit 103 analyzes the structure of the text in the original information acquired by the acquiring unit 101 (performs analysis in units of words or phrases, for example), by using the grammar dictionary stored in the storage unit 102. The translating unit 103 performs a translation process by using the basic term dictionary and the basic expression dictionary corresponding to a combination of the translation-source language and the translation-target language designated by the designation information acquired by the acquiring unit 101, and by using the technical term dictionary and the technical expression dictionary corresponding to a combination of the specialized field, the translation-source language, and the translation-target language designated by the designation information. The translating unit 103 generates a correspondence map, in which a translation result and the technical dictionary information used in the translation are associated with each other in units of words or phrases contained in the original information.

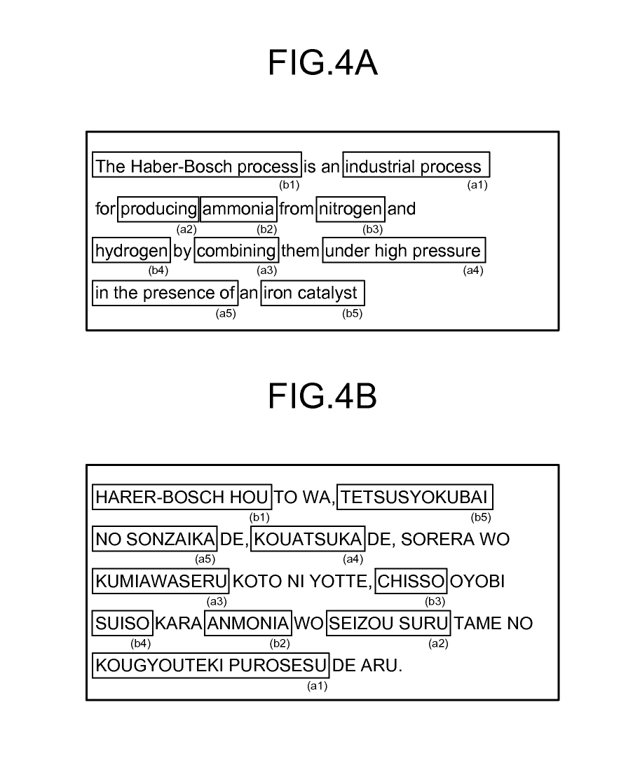

FIGS. 4A and 4B are diagrams illustrating an example of the correspondence map. In the example in FIGS. 4A and 4B, a1 to a5 illustrated in FIG. 4A correspond to a1 to a5 illustrated in FIG. 4B on a one-to-one basis. In this example, ax (x=1 to 5) illustrated in FIG. 4A corresponds to ax illustrated in FIG. 4B. For example, a1 illustrated in FIG. 4A corresponds to a1 illustrated in FIG. 4B, and a2 illustrated in FIG. 4A corresponds to a2 illustrated in FIG. 4B. In this example, a1 to a5 indicate that the dictionary information used in the translation is the basic dictionary information.

Similarly, b1 to b5 illustrated in FIG. 4A correspond to b1 to b5 illustrated in FIG. 4B on a one-to-one basis. In this example, bx (x=1 to 5) illustrated in FIG. 4A corresponds to bx illustrated in FIG. 4B. In this example, b1 to b5 indicate that the dictionary information used in the translation is the technical dictionary information.

Referring back to FIG. 3, the explanation will be continued. After generating the correspondence map as described above, the translating unit 103 determines whether the dictionary information used in the translation is the basic dictionary information or the technical dictionary information with respect to all of elements on the correspondence map (elements in units of words or phrases), and specifies elements for which the dictionary information used in the translation is the technical dictionary information. As described above, the translating unit 103 recognizes a word/phrase to be translated by using one or more pieces of the technical dictionary information corresponding to the specialized field designated by the designation information acquired by the acquiring unit 101 (in this example, a word/phrase to be translated by using the technical term dictionary or the technical expression dictionary corresponding to a combination of the specialized field, the translation-source language, and the translation-target language designated by the designation information) from among the words/phrases contained in the original information acquired by the acquiring unit 101.

The translating unit 103 adds information indicating a translation result of an element (translated text) to the element (word/phrase) specified as described above. In the following, the original information subjected to a process of adding a translation result of a word/phrase to only the word/phrase translated by using the technical dictionary information may be referred to as “translated information”. In this example, the translating unit 103 has functions corresponding to an “adding unit” in the appended claims; however, it is not limited thereto. For example, the functions corresponding to the “adding unit” in the appended claims may be provided separately from the translating unit 103.

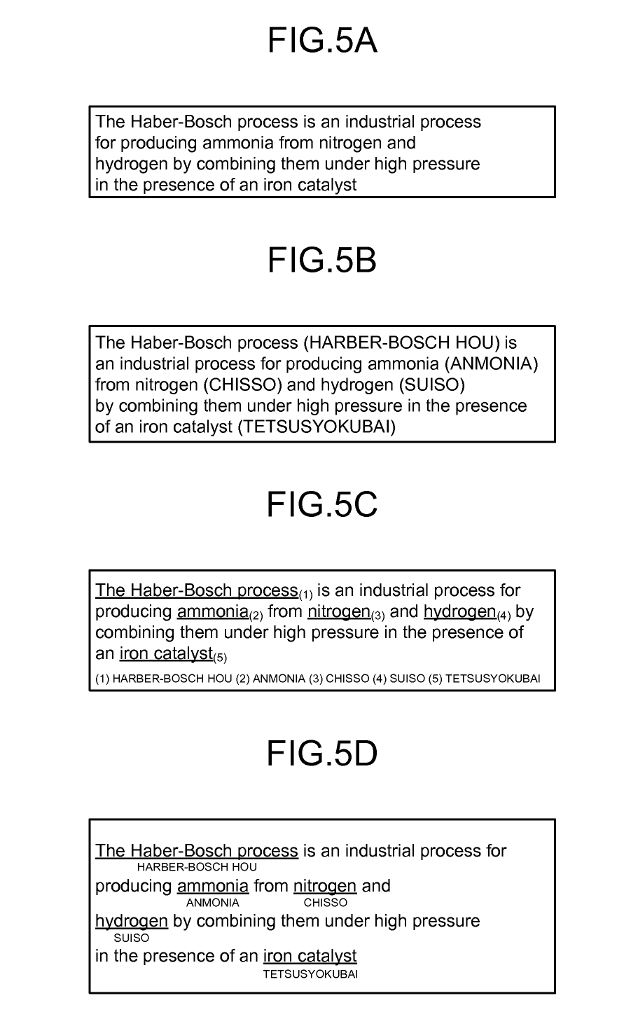

FIGS. 5A to 5D are diagrams illustrating an example of the translated information. In this example, a designated translation-source language is English, a translation-target language is Japanese, and a specialized field is chemistry. FIG. 5A illustrates the original information. In the example in FIGS. 5A to 5D, it is assumed that words/phrases to be translated by using the technical dictionary information corresponding to a combination of the translation-source language indicating “English”, the translation-target language indicating “Japanese”, and the specialized field indicating “chemistry” among words/phrases contained in the original are “The Haber-Bosch process”, “ammonia”, “nitrogen”, “hydrogen”, and “iron catalyst”. FIGS. 5B, 5C, and 5D illustrate examples of the translated information in this case.

The translating unit 103 can add information indicating translation results of words/phrases just after the words/phrases translated by using the technical dictionary information among the words/phrases contained in the original information. In the example in FIG. 5B, the translating unit 103 inserts Japanese text as the translation results in parentheses just after the words/phrases translated by using the technical dictionary information.

The translating unit 103 may display the words/phrases translated by using the technical dictionary information among the words/phrases contained in the original information in an emphasized manner, and add information indicating the translation results of the words/phrases to corresponding predetermined positions. In the example in FIG. 5C, the translating unit 103 underlines the words/phrases translated by using the technical dictionary information, assigns sequential numbers to the words/phrases, and displays Japanese text corresponding to the numbers in a margin. The way to perform display in an emphasized manner is arbitrary. For example, the translating unit 103 may highlight the words/phrases translated by using the technical dictionary information by adding a predetermined color to the words/phrases.

Further, the translating unit 103 may add information indicating the translation results of the words/phrases to portions above or below the words/phrases translated by using the technical dictionary information among the words/phrases contained in the original information. In the example in FIG. 5D, the translating unit 103 underlines the words/phrases translated by using the technical dictionary information, and displays Japanese text just below the words/phrases.

In the methods illustrated in FIGS. 5C and 5D, it may be possible to embed tag information, which is needed to display the translated information obtained through these method on a display unit (a display device that displays various images) of the PC 2 or the server 3, in the original. Further, words/phrases to be translated without using the technical dictionary information among the words/phrases contained in the original information are maintained as the original; therefore, in all of the cases in FIGS. 5B to 5D, translated text is not added to commonly-used words/phrases, such as “combining (ketsugo/gosei)” or “in the presence of (-no sonzaika)” (in the following description, such words/phrases may be referred to as “common words”). It may be possible to add a name of the technical dictionary information that has been used or a name of the field to the vicinity or the tail end of (for example, just after) the translated text in order to indicate which technical dictionary information is used for the translation, for example.

That is, a feature of the first embodiment is that a translation result is added to only a word/phrase that is translated by using a dictionary corresponding to a designated specialized field. In the first embodiment, translated text is added to only a technical word/phrase that may not be understood by even a user of high ability in translation among the words/phrases contained in the original information. Therefore, as compared to a configuration in which translated text is added to all of words/phrases including common words, it is possible to achieve an advantageous effect in that a result of the translation process is not complicated and a user may not be prevented from understanding the original.

Referring back to FIG. 3, explanation will be continued. The output unit 104 outputs the above described translated information. The way of output is arbitrary. For example, the output unit 104 may display the above described translated information on the display unit of the server 3, or transmit the above described translated information to the PC 2 in response to a request from the PC 2.

In the first embodiment, the server 3 is configured by a computer including a communication I/F to communicate with a CPU, a read only memory (ROM), a random access memory (RAM), the MFP 1, and the like, and the functions of each unit (the acquiring unit 101, the translating unit 103, and the output unit 104) of the server 3 as described above are implemented by causing the CPU to execute a computer program stored in the ROM or the like; however, it is not limited thereto. For example, at least a part of the functions of each unit (the acquiring unit 101, the translating unit 103, and the output unit 104) of the server 3 as described above may be implemented by a dedicated hardware circuit (for example, a semiconductor integrated circuit or the like). The above described storage unit 102 is implemented by, for example, a ROM, an external storage device (for example, a hard disk drive (HDD)), or the like.

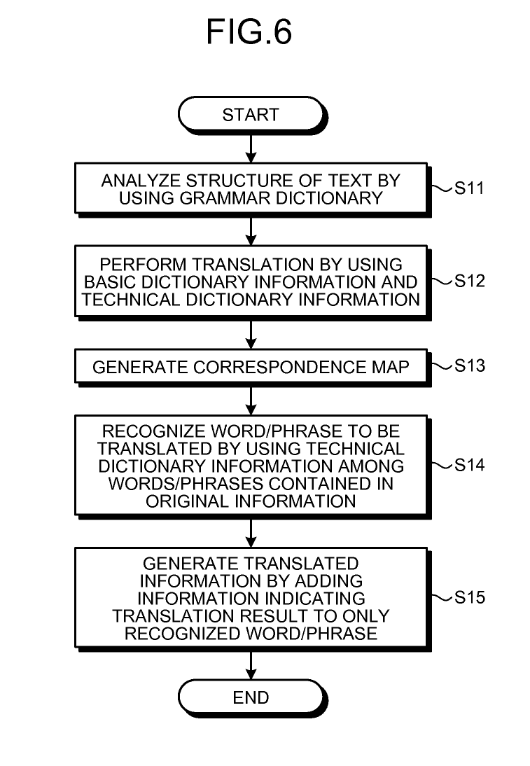

Next, with reference to FIG. 6, an example of operation of generating the translated information by the translating unit 103 will be described. FIG. 6 is a flowchart illustrating an example of the operation of generating the translated information by the translating unit 103. As illustrated in FIG. 6, the translating unit 103 first analyzes a structure of text in the original information acquired by the acquiring unit 101, by using the grammar dictionary (Step S11). Subsequently, the translating unit 103 performs a translation process by using the basic dictionary information and the technical dictionary information (Step S12). Specifically, as described above, the translating unit 103 performs the translation process by using the basic term dictionary and the basic expression dictionary corresponding to a combination of the translation-source language and the translation-target language designated by the designation information acquired by the acquiring unit 101, and by using the technical term dictionary and the technical expression dictionary corresponding to a combination of the specialized field, the translation-source language, and the translation-target language designated by the designation information.

The translating unit 103 generates a correspondence map, in which a translation result and the dictionary information used in the translation are associated with each other in units of words or phrases contained in the original information (Step S13). The translating unit 103 determines whether the dictionary information used in the translation is the basic dictionary information or the technical dictionary information with respect to all of elements on the correspondence map (elements in units of words or phrases), and specifies elements for which the dictionary information used in the translation is the technical dictionary information. In other words, the translating unit 103 recognizes (specifies) a word/phrase to be translated by using the technical dictionary information among the words/phrases contained in the original information (Step S14). The translating unit 103 generates translated information by adding a translation result of a word/phrase to only the word/phrase recognized at Step S14 among the words/phrases contained in the original information (Step S15). The above is an example of the operation of generating the translated information by the translating unit 103.

As described above, in the first embodiment, a translation result of a word/phrase is added to only the word/phrase translated by using the technical dictionary information corresponding to a designated combination of the specialized field, the translation-source language, and the translation-target language among the words/phrases contained in the original information. Therefore, as compared to a configuration in which the translation result is added to all of words/phrases including common words, a result of the translation process does not become complicated, a user may not be prevented from understanding the original, and the operation of searching for corresponding portions of the translation result with respect to the original can be reduced greatly. That is, according to the first embodiment, it is possible to reduce a burden on the user and assist in understanding of the original.

### Modification of First Embodiment

In the translation process, for example, it may be possible to specify (recognize), as words/phrases to be translated by using the technical dictionary information, the same words/phrases as words/phrases registered in the technical dictionary information corresponding to a designated combination of the translation-source language, the translation-target language, and the specialized field among words/phrases contained in the original information without using the grammar dictionary or the basic dictionary information, and may translate the specified words/phrases by using the technical dictionary information. Then, information indicating translation results may be added to the specified words/phrases. That is, any mode is applicable as long as words/phrases to be translated by using one or more pieces of the technical dictionary information corresponding to the designated specialized field are recognized from among the words/phrases contained in the original information, and information indicating translation results of words/phrases are added to only the recognized words/phrases.

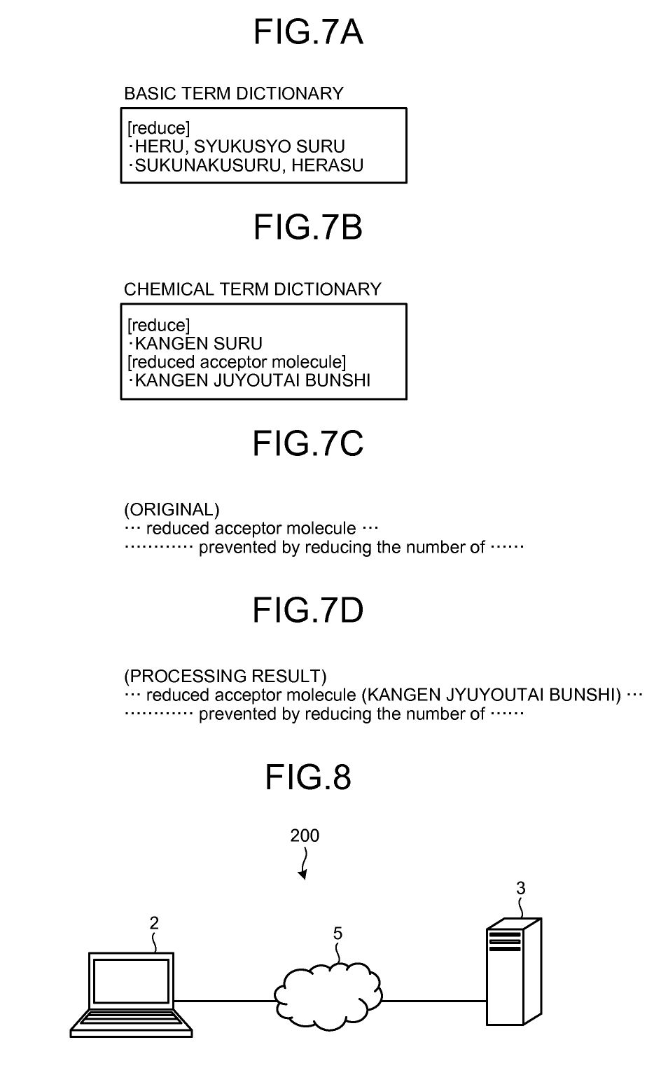

However, as in the first embodiment, it is preferable to perform a translation process by using the analysis result of the structure of text and the basic dictionary information together. This is because, as for a word/phrase having a meaning of a common word as well as a technical meaning, it is possible to improve the accuracy of determining whether the word/phrase is used in the specialized field when the translation process is performed by using the analysis result of the structure of text and the basic dictionary information together with the technical dictionary information. FIGS. 7A to 7D illustrate a specific example. An English word of “reduce” is used as a common word with a meaning of “decrease”, “shrink”, or the like, and is also used as a chemical term with a meaning of “gain of electrons” or the like, with which a number of compound words, such as “reduced acceptor molecule”, exist. In FIG. 7C, an English word of “reduce” is used both as a common word with a meaning of “decrease” and as a part of a chemical term of “reduced acceptor molecule”. When the text is analyzed by using the basic dictionary information (in this example, the basic term dictionary) and the technical dictionary information (in this example, a chemical term dictionary) together, it becomes possible not to translate both of the words into a word with a meaning of “gain of electrons”, but to analyze only a word of “reduced” in the “reduced acceptor molecule” as a word/phrase that is a chemical term with a meaning of “gain of electrons” and add translated text in accordance with context or connection with foregoing and following text as illustrated in a processing result in FIG. 7D.

### Second Embodiment

Next, a second embodiment will be described. Explanation of the same components as those of the above described first embodiment will be omitted. FIG. 8 is a diagram illustrating an example of a system 200 according to the second embodiment. As illustrated in FIG. 8, the system 200 includes the PC 2 and the server 3. In the example in FIG. 8, the PC 2 is connected to the server 3 via the Internet 5, and input and output are performed on a dedicated page on the server 3 accessed via a web browser of the PC 2. An example of a screen of the dedicated page will be described later.

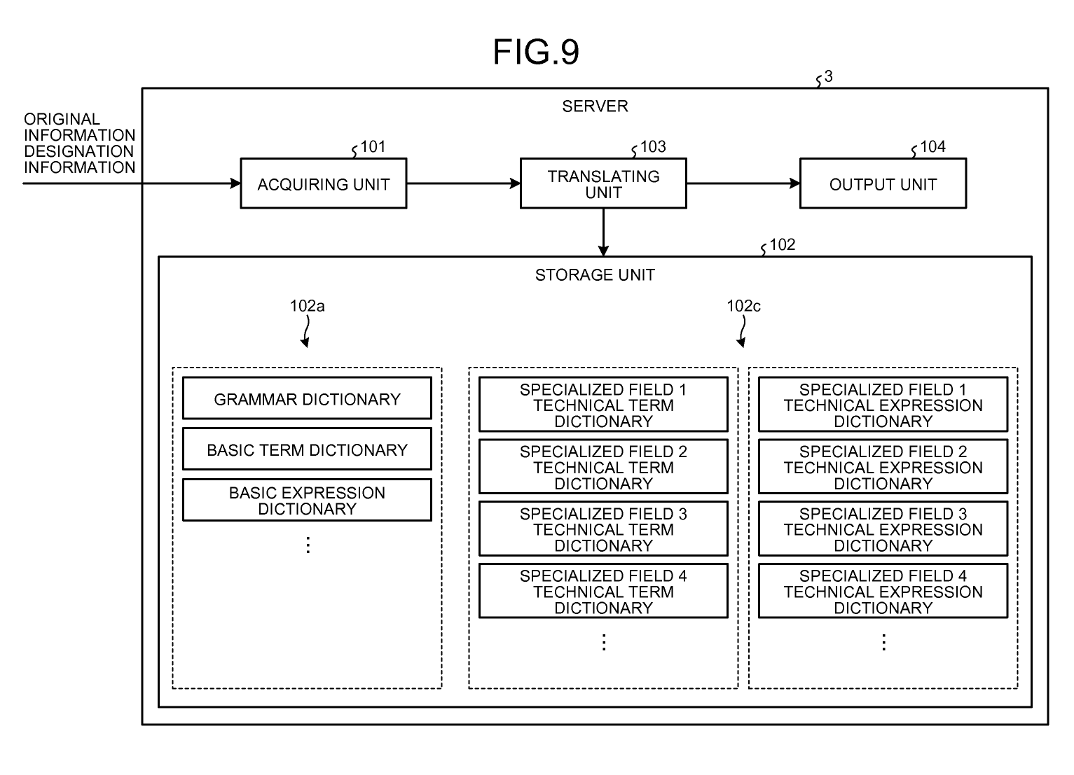

FIG. 9 is a diagram illustrating an example of a functional configuration of the server 3 according to the second embodiment. A feature of the second embodiment is that a technical data group 102c stored in the storage unit 102 is not classified by each of the specialized fields as in the above described first embodiment, but is classified by the types of dictionaries, such as a term dictionary or an expression dictionary. In this configuration, the number of each dictionary and the number of a classification need not be the same, and the specialized field is designated for each dictionary. Even in this configuration, it is possible to assume that the storage unit 102 stores therein, for each of the specialized fields, one or more pieces of the technical dictionary information used for translation of a word/phrase used in each of the specialized fields.

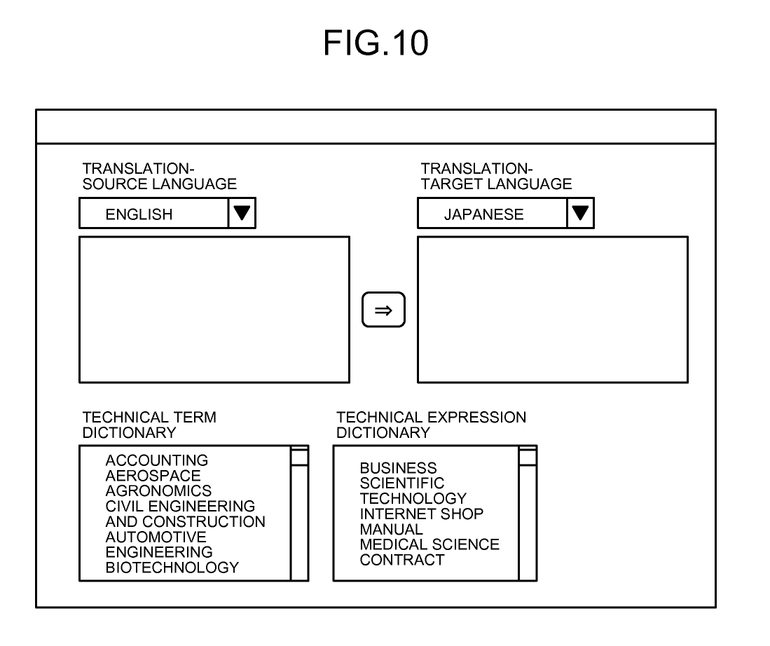

FIG. 10 is a diagram illustrating an exemplary screen of the dedicated page on the server 3 accessed via the web browser of the PC 2. On the page, the translation-source language and the translation-target language are selectable by pull-down, and when text (original) to be translated is input in a text area on the left side in the screen, the original information indicating the input original is transmitted to the server 3 and a returned processing result (the translated information as described above) is displayed in a text area on the right side in the screen. The specialized field is designated for each of the technical term dictionary and the technical expression dictionary. It is preferable that a plurality of the specialized fields are selectable for each of the dictionaries. In this configuration, the types and the classification methods need not be the same between the technical term dictionary and the technical expression dictionary, and are separately designated for each of the dictionaries by a user. Further, it may be possible to upload an original file and download a processing result as a file from the server 3, instead of inputting text on the page as in the exemplary screen.

The functions of the server 3 in the above described embodiments may be provided as a service used via a network, such as a cloud computing service, a service provided by an application service provider (ASP), or a web service. The above described server 3 may be a computer system as an assembly of one or more computers that may be plurally configured in a distributed manner. That is, it is sufficient that the translation system (a system including one or more computers) according to the embodiments includes the acquiring unit, the storage unit, the recognizing unit, and the adding unit. The acquiring unit acquires original information indicating text to be translated and designation information including information for designating a specialized field that is a field to which the original information belongs. The storage unit stores therein, for each of the specialized fields, one or more pieces of the technical dictionary information each being used as a dictionary for translation of a word/phrase used in each of the specialized fields. The recognizing unit recognizes a word/phrase to be translated by using one or more pieces of the technical dictionary information corresponding to the specialized field designated by the designation information among words/phrases contained in the original information. The adding unit adds information indicating a translation result of a word/phrase to only the word/phrase recognized by the recognizing unit.

In the above described embodiments, an example has been described in which an MFP (image forming apparatus) serves as a device that reads images. However, it may be possible to employ an apparatus that includes a scanner device or a reading unit (means), or an apparatus such as a mobile terminal, a smartphone, or a tablet that is implemented by an application.

The functions of the MFP 1 and the server 3 of the above described embodiments may be provided as a service used via a network, such as a cloud computing service, a service provided by an ASP, or a web service. In this case, a part of the functional configuration illustrated in FIG. 2 and FIG. 3 may be arranged on a server side (the server 3 or the like).

The computer program executed by the MFP 1 and the server 3 of the above described embodiments may be provided by being recorded in a computer-readable recording medium, such as a compact disc (CD)-ROM, a flexible disk (FD), a compact disc-recordable (CD-R), or a digital versatile disk (DVD), in a computer-installable or a computer-executable file format. The computer program may be provided or distributed via a network, such as the Internet. Various computer programs may be provided by being incorporated in a non-volatile recording medium, such as a ROM, in advance.

According to an embodiment, it is possible to reduce a burden on the user and assist in understanding of the original.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A translation system including one or more computers, the translation system comprising:
an acquiring unit that acquires original information indicating text to be translated and designation information including information for designating a specialized field that is a field to which the original information belongs;
a storage unit that stores therein, for each of specialized fields, one or more pieces of technical dictionary information each being used as a dictionary for translation of a word/phrase used in each of the specialized fields;
a recognizing unit that recognizes a word/phrase to be translated by using one or more pieces of the technical dictionary information corresponding to the specialized field designated by the designation information among words/phrases contained in the original information; and
an adding unit that adds information indicating a translation result of a word/phrase to only the word/phrase recognized by the recognizing unit.

2. The translation system according to claim 1, wherein
the designation information includes information for designating a translation-source language and a translation-target language,
the storage unit stores therein, for each combination of a translation-source language, a translation-target language, and a specialized field, at least first technical dictionary information indicating a correspondence relation between the translation-source language and the translation-target language for words used in the specialized field, and second technical dictionary information indicating a correspondence relation between the translation-source language and the translation-target language for phrases used in the specialized field, and
the recognizing unit recognizes a word/phrase to be translated by using the first technical dictionary information or the second technical dictionary information corresponding to a combination of the specialized field, the translation-source language, and the translation-target language designated by the designation information among the words/phrases contained in the original information.

3. The translation system according to claim 1, wherein the adding unit adds the information indicating a translation result of a word/phrase to a portion just after the word/phrase recognized by the recognizing unit.

4. The translation system according to claim 1, wherein the adding unit displays the word/phrase recognized by the recognizing unit in an emphasized manner, and adds the information indicating a translation result of the word/phrase to a corresponding predetermined position.

5. The translation system according to claim 1, wherein the adding unit adds the information indicating a translation result of the word/phrase to a portion above or below the word/phrase recognized by the recognizing unit.

6. The translation system according to claim 1, further comprising an output unit that outputs translated information indicating a result of a process that is performed on the original information by the adding unit.

7. The translation system according to claim 1, further comprising:
an analyzing unit that analyzes a structure of text in the original information, wherein
the recognizing unit recognizes a word/phrase to be translated by using one or more pieces of the technical dictionary information corresponding to the specialized field designated by the designation information among the words/phrases contained in the original information, by using a result of analysis by the analyzing unit.

8. The translation system according to claim 1, wherein
the word/phrase includes at least one of a word and a phrase,
the word is a smallest meaningful unit, and
the phrase indicates a sequence of words that collectively indicate a single meaning.

9. The translation system according to claim 1, wherein the specialized field includes at least one of a specialized field, a major field, a research field, and an academic field.

10. An information processing apparatus comprising:
an acquiring unit that acquires original information indicating text to be translated and designation information including information for designating a specialized field that is a field to which the original information belongs;
a storage unit that stores therein, for each of specialized fields, one or more pieces of technical dictionary information each being used as a dictionary for translation of a word/phrase used in each of the specialized fields;
a recognizing unit that recognizes a word/phrase to be translated by using one or more pieces of the technical dictionary information corresponding to the specialized field designated by the designation information among words/phrases contained in the original information; and
an adding unit that adds information indicating a translation result of a word/phrase to only the word/phrase recognized by the recognizing unit.

11. A computer program product comprising a non-transitory computer-readable medium having computer-readable program codes embodied in the medium, the program codes when executed causing a computer to execute:
acquiring original information indicating text to be translated and designation information including information for designating a specialized field that is a field to which the original information belongs;
specifying one or more pieces of technical dictionary information corresponding to the specialized field designated by the designation information by referring to a storage unit that stores therein, for each of specialized fields, one or more pieces of technical dictionary information each being used as a dictionary for translation of a word/phrase used in each of the specialized fields;
recognizing a word/phrase to be translated by using one or more pieces of the technical dictionary information specified at the specifying among words/phrases contained in the original information; and
adding information indicating a translation result of a word/phrase to only the word/phrase recognized at the recognizing.

12. The computer program product according to claim 11, wherein
the designation information includes information for designating a translation-source language and a translation-target language,
the storage unit stores therein, for each combination of a translation-source language, a translation-target language, and a specialized field, at least first technical dictionary information indicating a correspondence relation between the translation-source language and the translation-target language for words used in the specialized field, and second technical dictionary information indicating a correspondence relation between the translation-source language and the translation-target language for phrases used in the specialized field, and
the recognizing includes recognizing a word/phrase to be translated by using the first technical dictionary information or the second technical dictionary information corresponding to a combination of the specialized field, the translation-source language, and the translation-target language designated by the designation information among the words/phrases contained in the original information.

13. The computer program product according to claim 11, wherein the adding includes adding the information indicating a translation result of a word/phrase to a portion just after the word/phrase recognized at the recognizing.

14. The computer program product according to claim 11, wherein the adding includes displaying the word/phrase recognized at the recognizing in an emphasized manner, and adding the information indicating a translation result of a word/phrase to a corresponding predetermined position.

15. The computer program product according to claim 11, wherein the adding includes adding the information indicating a translation result of a word/phrase to a portion above or below the word/phrase recognized at the recognizing.

16. The computer program product according to claim 11, further comprising outputting translated information indicating a result of a process that is performed on the original information at the adding.

17. The computer program product according to claim 11, further comprising:
analyzing a structure of text in the original information, wherein
the recognizing includes recognizing a word/phrase to be translated using one or more pieces of the technical dictionary information corresponding to the specialized field designated by the designation information among the words/phrases contained in the original information, by using a result of analysis at the analyzing.

18. The computer program product according to claim 11, wherein
the word/phrase includes at least one of a word and a phrase,
the word is a smallest meaningful unit, and
the phrase indicates a sequence of words that collectively indicate a single meaning.

19. The computer program product according to claim 11, wherein the specialized field includes at least one of a specialized field, a major field, a research field, and an academic field.
